(19) United States
(12) Patent Application Publication
(10) Pub. No.: US 2026/0043532 A1
(43) Pub. Date: Feb. 12, 2026

(54) SYSTEM AND METHOD FOR WORK AND SCENE LIGHTING

(71) Applicant: WHELEN ENGINEERING COMPANY INC., Chester, CT (US)

(72) Inventors: Sean Patrick Brown, Berlin, CT (US); Kristopher Allan Terpe, Cobalt, CT (US); Todd Jeffery Smith, Deep River, CT (US); David Joseph Sousa, Ivoryton, CT (US)

(73) Assignee: WHELEN ENGINEERING COMPANY INC., Chester, CT (US)

(21) Appl. No.: 19/177,763

(22) Filed: Apr. 14, 2025

Related U.S. Application Data
(60) Provisional application No. 63/633,489, filed on Apr. 12, 2024.

(51) Int. Cl. F21V 7/24; F21V 7/00; F21V 23/00; F21V 23/02; F21Y 115/10; H05B 45/12; H05B 47/155

(52) U.S. Cl. CPC F21V 7/24; F21V 7/0033; F21V 23/004; F21V 23/023; H05B 45/12; H05B 47/155; F21Y 2115/10

(57) ABSTRACT

Systems and methods are directed toward a light head including two or more different optical axes. A first optical axis may correspond to a near field lighting area and the second optical axis may correspond to a far field lighting area. The light head may be positioned within a retainer to couple the light head to an enclosure. The retainer may include one or more gripping components to secure movement of the light head in at least three directions and also provide opposing spring forces to block rotational movement of the light head.

### CROSS-REFERENCE TO RELATED APPLICATION(S)

This Non-Provisional Patent Application is related to and claims the benefit of priority from U.S. Provisional Application No. 63/633,489, titled “SYSTEM AND METHOD FOR WORK AND SCENE LIGHTING,” filed on Apr. 12, 2024, and incorporated by reference herein in its entirety for all intents and purposes.

### BACKGROUND

### 1. Field of Disclosure

At least one embodiment pertains to light heads for illuminating two or more optical axes. The light heads may be included in individual lighting assembly modules, and more than one module may be connected to the same mounting extrusion or surface. More specifically, at least one embodiment pertains to a lighting assembly to secure one or more light heads.

### 2. Description of Related Art

Light heads may be used to illuminate various scenes. Generally, light heads include one or more light sources with optics to reflect and/or direct light generated by the light sources. The optics may be limited to a single optical axis, and as a result, different light heads are used to illuminate different scenes. For example, a first light head may be used for a near field area and a second light head may be used for a far field area. Multiple light heads may be onerous to transport and/or may be costly.

One example of a prior art light stick assembly includes individual light heads that are front loaded into an extrusion with a plastic molded snapping clip/retainer used to hold the light heads in place. One snapping clip/retainer may be used to hold one end of two adjacent light heads, and as a result, the relation of light heads to snapping clip/retainers is not 1:1. The snapping clip/retainer is also a divider and segments the different light heads. As another example, certain other prior art assemblies consist of individual light heads that snap into a molded, plastic carrier, and then front load into an extrusion. A snapping clip is then used between the different carriers in the array to snap and hold them into place. In certain prior art assemblies, the snaps were not sufficient during shipping and the light stick assemblies were coming apart.

### SUMMARY

Applicants recognized the problems noted above herein and conceived and developed embodiments of systems and methods, according to the present disclosure, for mounting panels using an adhesive mounting method.

In an embodiment, a light assembly includes one or more light heads, one or more retainers configured to couple to the one or more light heads, and an enclosure configured to receive the one or more retainers to secure the one or more light heads in a desired orientation.

In another embodiment, a light head includes a printed circuit board arranged at an angle, a first light section, and a second light section. The first light section includes a first light source, a first reflector, and a second reflector. The first light source includes a first optical axis that is normal to the printed circuit board. The second light section includes a second light source, a third reflector, a fourth reflector, a collimator, and two or more diamond optical reflectors. The second light source includes a second optical axis that is at a second angle, the second angle being oblique to the first angle of the printed circuit board, and the second angle being substantially parallel to a ground plane.

In another embodiment, a method includes determining a first power level for a first light source, causing the first light source to operate at the first power level, determining a second power level for a second light source, determining a total power level based on the first power level and the second power level, determining the total power level exceeds a threshold power level, determining a modified first power level, causing the first light source to operate at the modified first power level, and causing the second light source to operate at the second power level.

In yet another embodiment, a retainer for holding a light head, attachable to an enclosure, includes a frame that includes one or more apertures, one or more front top members configured to apply force to an upper interior part of an enclosure, one or more front bottom members configured to apply force to a bottom interior part of the enclosure, one or more rear members connectable to one or more catches in the extrusion, and one or more safety members comprising one or more pads, the one or more safety members ensuring the attachment of the retainer to the enclosure.

### BRIEF DESCRIPTION OF DRAWINGS

The present technology will be better understood on reading the following detailed description of non-limiting embodiments thereof, and on examining the accompanying drawings, in which:

FIG. 1 illustrates an exploded schematic view of an embodiment of a light assembly, in accordance with at least one embodiment;

FIG. 2 illustrates a cross-sectional side view of an embodiment of a light head, in accordance with at least one embodiment;

FIG. 3 illustrates schematic diagram of an embodiment of an illumination package, in accordance with at least one embodiment;

FIG. 4 illustrates schematic perspective view of an embodiment of an illumination package, in accordance with at least one embodiment;

FIG. 5 illustrates schematic diagram of an embodiment of a control system, in accordance with at least one embodiment;

FIG. 6 illustrates an example process for adjusting a power level for a light source, in accordance with at least one embodiment;

FIG. 7 is a front isometric view of an embodiment of a retainer, in accordance with embodiments of the present disclosure;

FIG. 8 is a rear isometric view of an embodiment of a retainer, in accordance with embodiments of the present disclosure;

FIG. 9 is a front view of an embodiment of a retainer, in accordance with embodiments of the present disclosure; and

FIG. 10 is a side view of an embodiment of an expanded light stick assembly, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Systems and methods of the present disclosure are directed toward a light assembly that may include one or more light heads, one or more retainers, and one or more enclosures. The light assembly may provide a compact package that may be used to mount the light assembly to a variety of items, including vehicles, poles, and/or the like. In at least one embodiment, the light assembly may include a plurality of light heads that are individually removable from the light assembly, thereby providing flexibility with operation, maintenance, replacement, and/or the like. Systems and methods may include a light head that includes optics to facilitate multi-field operation. Furthermore, the one or more retainers may be used to securely couple the one or more light heads to the enclosure to protect and secure the light heads during use and/or shipping. The one or more retainers and/or one or more enclosures may be fastener-less containers that use friction, spring forces, and/or the like to secure the one or more light heads at a desired position.

Various embodiments are directed toward a light head that may include at least two light sources mounted on a common printed circuit board (PCB) (e.g., board, mount, etc.). The light sources may include light emitting diodes (LEDs) that are configured to direct light along two different optical axes. The different optical axes may be associated with providing work lighting (e.g., “near field lighting,” “close range lighting,” “ground lighting,” “near field illumination,” “close range illumination,” “ground illumination,” etc.) and scene lighting (e.g., “far field lighting,” “forward lighting,” “long range lighting,” “distance lighting,” “far field illumination,” “forward illumination,” “long range illumination,” “distance illumination,” etc.). For example, one or more LEDs configured to direct light along an optical axis associated with a near field may provide flood or scene lighting in an area around an emergency vehicle, as one non-limiting example, to which the light head is mounted. And, one or more LEDs configured to direct along an optical axis associated with a far field may provide light directed at areas farther away from the emergency vehicle, such as spot lights or distance lighting. In at least one embodiment, the common board may further include optics and/or reflective elements in order to collect, direct, and focus light toward a desired optical axis. In various embodiments, the at least two light sources may be powered and controlled by circuitry that may be used to dynamically adjust brightness of the at least two light sources based on a power limit, among other options. Systems and methods may further be used with control systems that facilitate dynamic synchronization between light sources associated with a variety of different light assemblies. Moreover, the light heads may be mounted on emergency vehicles, and the light heads can be controlled such that light heads on a single emergency vehicle are synchronized with each other or controlled to otherwise have coordinated flash patterns. And, light heads on multiple, different vehicles, can also be controlled such that their flash patterns and light output are coordinated or synchronized.

In at least one embodiment, a plastic, molded component (e.g., a “retainer”) is included in a light stick assembly that allows for removability and serviceability with a simple tool. The light stick assembly (comprised of daisy-chained light heads) houses the retainer; the retainer snaps onto the back of a single light head, and then acts as the carriage for that light head as that light-head subassembly then snaps into an extrusion of the light stick. Once snapped in, a simple tool may be used to remove the light head and retainer from the extrusion of the light stick assembly, prohibiting undesired disassembly. The snapping functionality of the light head into the retainer allows for toolless assembly, as well as simplified serviceability.

Embodiments of the present disclosure may address and overcome problems with prior art assemblies. By way of example, configurations discussed herein may provide assemblies that remove divisive retainers to achieve a contiguous aesthetic appeal and output between light heads. Furthermore, embodiments may also include one or more safety features to ensure human input is required for disassembly. Accordingly, systems and methods may provide an improved visual appeal because retainers discussed herein may remain hidden (e.g., fully hidden, substantially fully hidden, etc.), as opposed to prior art configurations where retainers and other structures are visible, both breaking up the visual appeal and disrupting light output. In this manner, embodiments of the present disclosure may provide an aesthetically pleasing cool and also an evenly distributed light pattern for a populated array.

The one or more safety features in the retainer ensure an assembly that is held together without any industry-standard mechanical fasteners and can remain assembled throughout all operating conditions. Furthermore, the one or more safety features provide improved serviceability that may be conducted with the simple, easily obtainable tools, ensuring the service team will be equipped to complete the service operations.

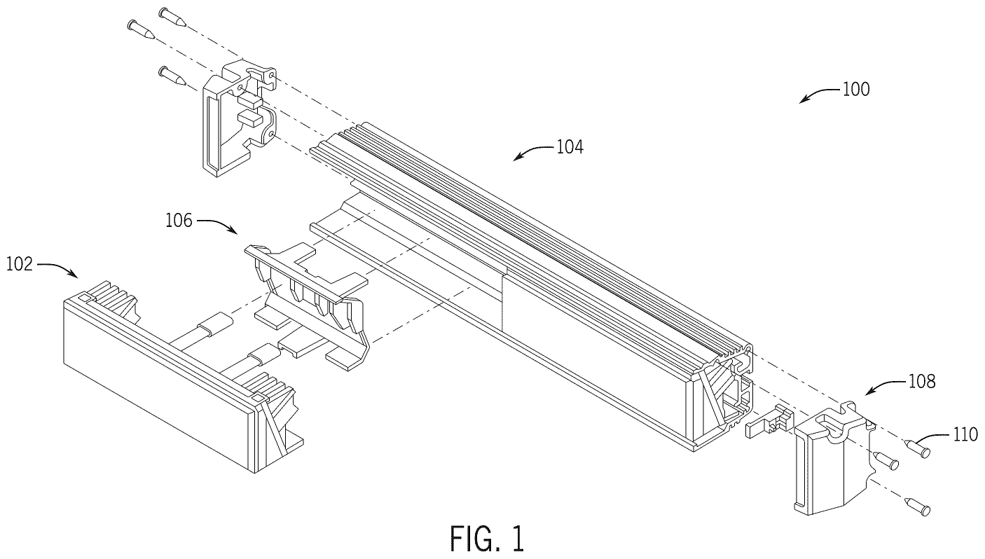

FIG. 1 illustrates an exploded perspective view of a light assembly 100. In this example, the light assembly 100 includes light heads 102 that are coupled to an enclosure 104 using one or more retainers 106. As discussed herein, the light heads 102 may include two or more light sources that permit emission of light along two different axes. Accordingly, the light heads 102 may be used to illuminate a variety of different scenarios, such as both near field and far field scenarios, among various other options.

The illustrated light head 102 may be coupled to the retainer 106, which may be used to secure the light heads 102 to the enclosure 104, as discussed herein. The retainer 106 may reduce and/or remove fasteners for the connection of the light heads 102 to the enclosure 104. However, as shown in FIG. 1, other features, such as end caps 108, may be coupled to the enclosure 104 using one or more fasteners 110 in at least one embodiment. The retainer 106 may be driven into an opening of the enclosure 104 and engage one or more features of the enclosure 104 such that a spring force and/or an interference fit blocks movement of the retainer 106 relative to the enclosure 104 absent one or more release forces. Furthermore, the retainer 106 may couple to the light head 102 along a back side and/or without obscuring a front plate, thereby reducing interference with light output, reducing gaps between adjacent light heads 102 within the assembly 100, and also providing a more aesthetically pleasing appearance.

It should be appreciated that the configuration of FIG. 1 is provided by way of non-limiting example and is not intended to limit the scope of the present disclosure. For example, there may be more than two light heads 102 associated with a single light assembly 100. Additionally, the fasteners 110 may be omitted for other coupling mechanisms, such as interference fits, adhesives, clamps, clips, and/or the like. Furthermore, in at least one embodiment, a common retainer 106 may be used for each light head 102 of the light assembly 100. As another example, a retainer 106 may be configured to hold multiple light heads 102, but not all light heads for the light assembly 100.

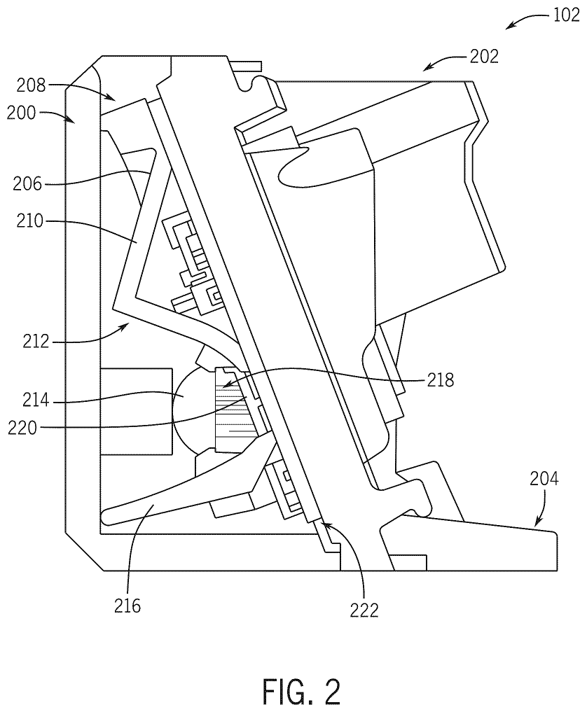

FIG. 2 illustrates a cross-sectional side view of an embodiment of the light head 102. The illustrated light head 102 includes an illumination package 200, an electronics package 202, a support structure 204. The illumination package 200 includes a first light source 206 (e.g., a flood light source, a scene light source, etc.), which may be an LED, a first reflector 208 (e.g., a top reflector, a top reflector for a flood source, etc.), a second reflector 210 (e.g., a bottom reflector, a bottom reflector for a flood source, etc.), a third reflector 212 (e.g., a top reflector, a top reflector for a forward illumination source, etc.), a collimator 214, a fourth reflector 216 (e.g., a bottom reflector, a bottom reflector for a forward illumination source, etc.), a diamond optical reflector 218, a second light source 220 (e.g., a forward illumination light source), and a PCB 222.

In at least one embodiment, the light head 102 is configured for both forward illumination and food/scene illumination. As discussed herein, different sections of the light head may be arranged and configured to illuminate different areas in the vicinity of the light head 102, and as a result, different scenes or areas may be illuminated using a common light head that may be positioned within a compact design package. As shown, the PCB 222 is arranged at an angle to put the first light source 206 at the focal point of the reflector 208. The first light source, in coordination with reflectors 208, 210, provides light in a near field area to illuminate the scene around the light head 102. As will be discussed herein, the first light source 206 emits light, some of which is reflected by first and second reflectors 208, 210 such that the first reflector 208 directs emitted light from the first light source 206 downwards and the second reflector 210 spreads the emitted light from the first light source 206 at an angle toward a ground location. In at least one embodiment, the remainder of the emitted light from the first light source 206 is Lambertionally spread on the ground without aid from the first or second reflectors 208, 210. Further illustrated in FIG. 2 is second light source 220, which in coordination with other components, provides far field or forward illumination. For example, the light head 102 includes third and fourth reflectors 212, 216 coupled to the collimator 214 and the diamond optic reflector 218. As a result, the diamond optic reflector 218 may reduce the second light source 220 light spread, for example, by positioning a first and second diamond optical reflector laterally on each side of the second light source 220. In operation, the third and fourth reflectors 212, 216 redirect the Lambertian output of the second light source 220 to collimate the output. The collimator 214 may capture the remaining output that is not captured from the third and fourth reflectors 212, 216 and collimate the second light source 220 Lambertian pattern output. In at least one embodiment, an optical axis of the flood illumination section may be approximately normal to the PCB 222 and an optical axis of the forward illumination section may be approximately horizontal (e.g., 0 degrees).

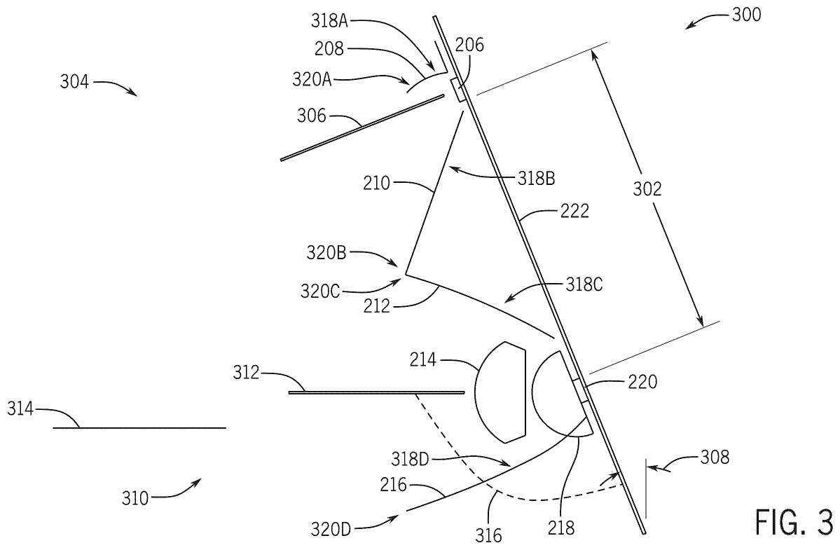

FIG. 3 illustrates a schematic representation 300 of the illumination package 202. In this example, the first light source 206 is arranged a distance 302 from the second light source 220, which may be particularly selected based on one or more design conditions, such as a desired overall assembly height, operating parameters of the light sources 206, 220, and/or the like. Although FIG. 3 is shown schematically, it should be appreciated that various components may be coupled together and/or formed as one or more unitary components that are attached together. By way of non-limiting example, the first reflector 208, the second reflector 210, the third reflector 212, the fourth reflector 216, and the diamond optical reflector 218 may be coupled together and/or formed as one or more singular components. The assembly may be formed from a variety of materials, such as plastics, and may include different features to enhance light reflection.

In at least one embodiment, the first light source 206 may be an LED and may be associated with a flood section 304 (e.g., a scene section). As shown, a flood optical axis 306 is illustrated extending from the first light source 206 and is associated with a direction of light emitted by the first light source 206 and/or reflected using one or both of the first reflector 208 and/or the second reflector 210. In this example, the flood optical axis 306 is normal to the PCB 222, which is arranged at an angle 308. The angle 308 may be particularly selected based on one or more desired design conditions. As one non-limiting example, the angle 308 is approximately 21 degrees. However, the angle 308 may be greater than or less than approximately 21 degrees. For example, the angle may be between approximately 10 and approximately 20 degrees, between approximately 20 and approximately 30 degrees, between approximately 30 and approximately 40 degrees, between approximately 40 and approximately 50 degrees, or any other reasonable range.

In operation, the first reflector 208 may be considered a shallow reflector and may redirect light emitted from the first light source 206 to a ground location. In at least one embodiment, the angle 308 of the board and relative sizes the respective reflectors 208, 210, 212, 216 angle the downward lighting of the first reflector 208 without interference. The first reflector 208 may be an elliptical reflector. Additionally, the second reflector 210 may also receive and reflect light emitted from the first light source 206 along the flood optical axis 306. Accordingly, systems and methods of the present disclosure may use the flood section 304 for near field illumination, which may be between approximately the light location and 10 yards away.

In at least one embodiment, the second light source 220 may be an LED and may be associated with a forward illumination section 310. As shown, a forward illumination optical axis 312 is illustrated extending from the second light source 220 and is associated with a direction of light emitted by the second light source 220 and/or reflected using at least one of the third reflector 212, the fourth reflector 216, the diamond optical reflector 218, and/or the collimator 214.

In this example, the forward illumination optical axis 312 is parallel to a ground plane 314, which is substantially flat in this example (e.g., at zero degrees). It should be appreciated that the forward illumination optical axis 312 may also be described as being arranged at an angle 316 with respect to the PCB 222. As one non-limiting example, the angle 316 may be approximately 69 degrees, However, the angle 316 may be greater than or less than approximately 69 degrees and may be a function of the angle 308 (e.g., the sum of the angles 308 and 316 may equal 90 degrees).

While the illustrated schematic includes a view of a single diamond optical reflector 218, it should be appreciated that there may be two or more diamond optical reflectors 218 that are arranged laterally with respect to the second light source 220 in order to capture light from the left and right sides. The diamond optical reflectors 218 may be particularly selected and positioned based on a desired angle of capture with respect with the second light source 220 (e.g., approximately 120 degrees, approximately 140 degrees, etc.). The diamond optical reflectors 218 may be substantially conically shaped, with a “tip” of the conical shape facing the second light source 220. As light is emitted from the second light source 220, the light may be directed toward the sides (e.g., laterally out) and may be captured by the diamond optical reflectors 218 and then directed toward at least one of the third reflector 212, the collimator 214, and/or the fourth reflector 216. The remaining light emitted from the second light source 220 may be reflected by the third and fourth reflectors 212, 216 and/or output through the collimator 214. Accordingly, systems and methods of the present disclosure may use the forward illumination section 310 for far field illumination, which may be between approximately 10 yards and 20 yards away from the light source.

It should be appreciated that various dimensions of the various components may be particularly selected based on one or more desired operating conditions. For example, one or more horizontal extents 318 for the first reflector 208, second reflector 210, third reflector 212, and/or fourth reflector 216 may be selected such that there is a vertical alignment between various end locations 320A-302D. Similarly, various components may be arranged based on the positioning of the different light sources 206, 220.

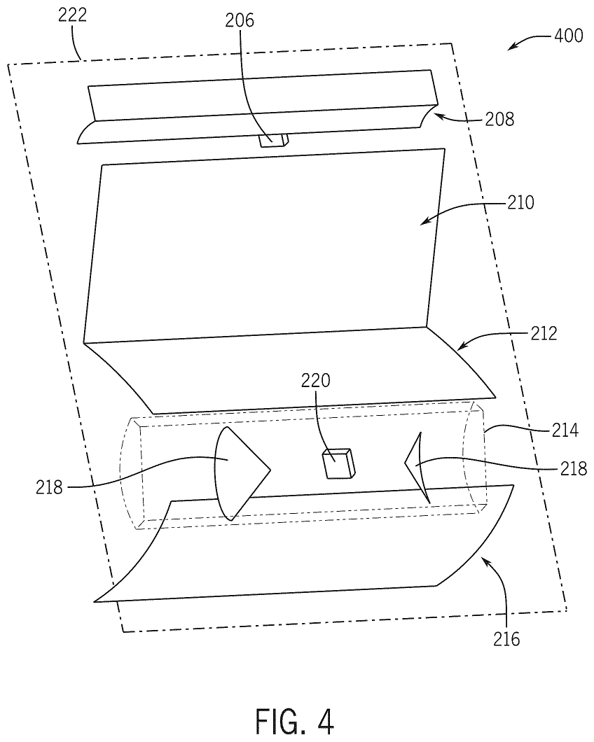

FIG. 4 is a schematic perspective view of an embodiment of the illumination package 200. As shown in this example, the various components may be arranged such that they are coupled together and/or formed from different unitary components. Each of the components is illustrated mounted, at least in part, on the PCB 222. The illustrated configuration includes the first reflector 208, the second reflector 210, the third reflector 212, the collimator 214, and the fourth reflector 216 being coupled together to form a reflective component, which may be a plastic component. Further shown in this example is the pair of diamond optical reflectors 218, which are arranged laterally outward with respect to the second light source 220. As discussed, the relative locations may be based, at least in part, on desired operating conditions, such as a range of light to capture, among other variables.

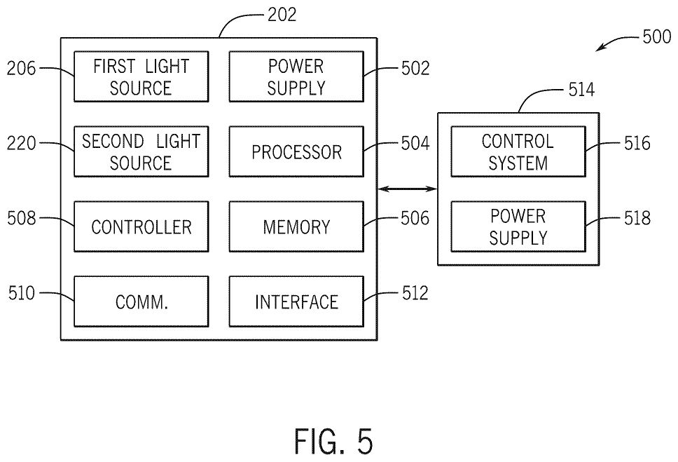

FIG. 5 illustrates a schematic control system 500 that may be used with embodiments of the present disclosure. In this example, one or more elements may be shown as being part of or associated with other elements, but it should be appreciated that such description is by way of non-limiting example and that different elements may be remotely located and/or coupled to other elements using one or more wired or wireless connections, among other options. In this example, the electronics package 202 may be associated with one or more light heads. For example, the electronics package 202 may be coupled to the light head. The illustrated electronics package 202 includes the first light source 206, the second light source 220, a power supply 502, a processor 504, one or more memories 506, a controller 508, a communication component 510, and an interface 512.

The processor 504 may include one or more microprocessors, which may include different central processing units (CPUs), graphics processing units (GPUs), data processing units (DPUs), and/or combinations thereof. In at least one embodiment, the processor 504 may be a limited processor or a dedicated processor associated with a system on a chip designed and designated to perform operations associated with the light head. The processor 504 may include a variety of different processors, such as PENTIUM®, Xeon™, Itanium®, XScale™, StrongARM™, Intel® Core™, or Intel® Nervana™ microprocessors available from Intel Corporation of Santa Clara, California, and/or various others. The one or more memories 506 may include a dynamic random access memory (DRAM) device, a static random access memory (SRAM) device, flash memory device, phase-change memory device, or some other memory device. The communication component 510 may be a wired or wireless communication component, such as a Near Field Communications unit (“NFC”) a wireless local area network unit (“WLAN”), a Bluetooth unit, a Wireless Wide Area Network unit (“WWAN”), or any other suitable communication device.

In operation, the power supply 502 may receive a command signal from the controller 208 to provide a designated power level to one or both of the first light source 206 and/or the second light source 220. For example, an operator may interact with the interface 512, which may be a button, a touch screen interface, a selectable dial, or an interface to facilitate communication with one or more personal devices, among other options. The power supply 502 may receive the signal and then provide an associated level of power, where the level of power provided may be monitored to determine whether or not a maximum power level is exceeded. For example, a maximum level of power may be specified such that both of the first light source 206 and the second light source 220 may not simultaneously operate using a respective maximum power level, as discussed here.

In at least one embodiment, the communication unit 510 may communicate with one or more personal devices and/or with one or more remote control units 514. The remote control unit 514 may include a control system 516 that provides commands to the electronics package 202 and/or a separate or additional power supply 518. In this manner, control of the electronics package 202 may be performed remote from the light head.

In at least one embodiment, one or more operations of the light head may coordinate or otherwise be controlled with one or more additional or nearby light heads. For example, if the light head were operating as a strobe or blinking operational configuration along with others, multiple blinking lights, at different rates, may be distracting to those nearby. Systems and methods may enable coordination such that blinking or strobing is synchronized between different light heads within an area or associated with the same controller. Light heads on the same vehicle may be synchronized or otherwise controlled to coordinate their flash patterns. And, light heads on multiple vehicles may be coordinated or synchronized together. This may be done by including a communication interface associated with each light head that connects the light head to a controller. Further, more than one controller can be included and may be associated with multiple emergency vehicles. The communication interfaces can be wired or wireless interfaces. Wired interfaces may include, for example, CAN buses, wires, or cables. Wireless interfaces may include, for example, wide area network (WAN) interfaces, local area network (LAN) interfaces, cellular communications, WiFi, or radio frequency communications.

Embodiments of the present disclosure may also be used to control maximum power dissipation for a package of light sources. For example, if a package of light sources were to exceed a maximum or desired power dissipation, useful life may be decreased. Systems and methods of the present disclosure address and overcome problems associated with existing design guidelines where output power of individual light sources are lowered to levels that would not exceed a package maximum level. With existing approaches, there is lower light performance when only a single light source is active. As discussed herein, embodiments provide for a light head with two light sources to provide both near field and far field lighting. In at least one embodiment, near field may refer to a wide area “flood light” effect and a far field light source may refer to a lighting configuration designed to illuminate distant objects. The light head of the present disclosure provides a user with the ability to select either or both light sources. With any selection option, it is desirable to achieve the maximum light output that the package can handle. Furthermore, in at least one embodiment, it may be desirable to utilize Dynamic Variable Intensity (DVI) turn on and turn off to provide a progressive application (or reduction) of power to the lamp over a period of time, resulting in a smoother appearance. For example, the lights may be controlled such that the intensity ramps up and down over a predetermined or controllable interval, through control of the LEDs. The intensity may ramp up and down without ever going to zero, or being completely off.

In one example operational configuration, it is assumed that both light sources within the lamp are off. When a command is received to energize the far field input, the processor begins ramping up the power to the far field light source at a rate determined by firmware. As a result, the far field light may progressively increase until it reaches a designated level, such as, but not limited to, 100 percent. If another command is received to energize the near field input, then the processor begins ramping up the power to the near field light source at a rate determined by firmware. In operation, systems and methods may also monitor and ensure that the sum of the power to the two light sources does not exceed a designated maximum level. For example, while the ramping of the near field light is occurring, the processor may compute, or have already computed, the total power for the two light sources. As one example, if the far field light source were initially at 100 percent output and a command was received to power the near field light source to 10 percent, then the processor would automatically compute and reduce the power output for the far field light source to 90 percent. This process may continue until a desired level were reached for one or both of the light sources.

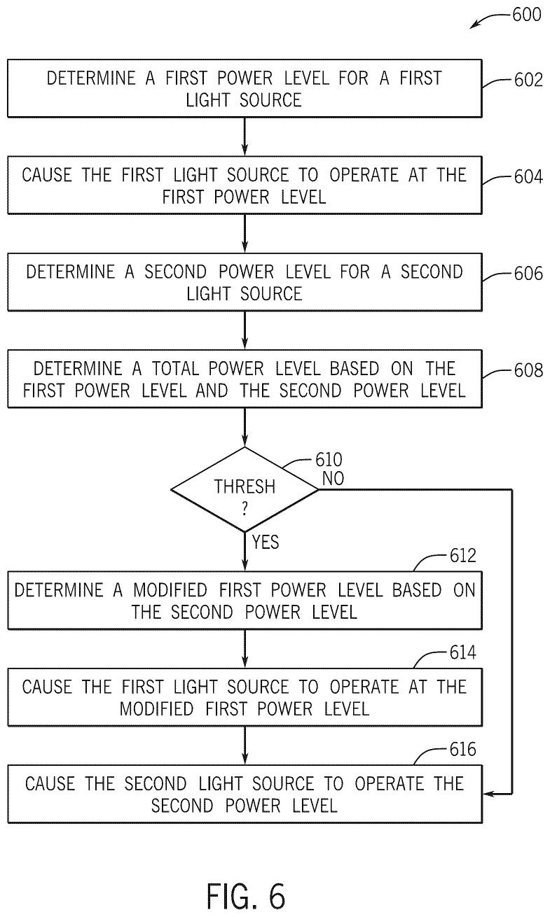

FIG. 6 illustrates an example process 600 that can be used to monitor and adjust power settings for a light head, in accordance with embodiments of the present disclosure. It should be understood that for this and other processes presented herein that there may be additional, fewer, or alternative operations performed in similar or alternative orders, or at least partially in parallel, within the scope of the various embodiments unless otherwise specifically stated. In this example, a first power level for a first light source is determined 602. The first power level may correspond to an input command received to operate the first light source at a designated power level. The first light source may then operate at the first power level 604. Another command may be received to determine a second power level for a second light source 606. For example, a second light source may have initially been off, and therefore not receiving any power, and then a command may be received to provide power to the second light source. In at least one embodiment, a total power level may be determined 608. The total power level may be based on the first power level and the second power level. It may be determined whether the total power level exceeds a threshold 610 (e.g., a maximum power threshold, a target power threshold, etc.). If so, then a modified first power level may be determined 612. The modified power level may be a different between the first power level and the second power level. For example, if the first power level were at 100 percent and the second power level were designated at 50 percent, then the first power level may be reduced to 50 percent for the modified first power level. As another example, if the first power level were at 60 percent and the second power level was designated at 70 percent, then the second power level may be reduced to 40 percent. The first power level may then be operated at the modified first power level 614. Additionally, in at least one embodiment, the second light source may be set to operate at the second power level 616. In this manner, power levels for different light sources may be adjusted to prevent exceeded a maximum power threshold.

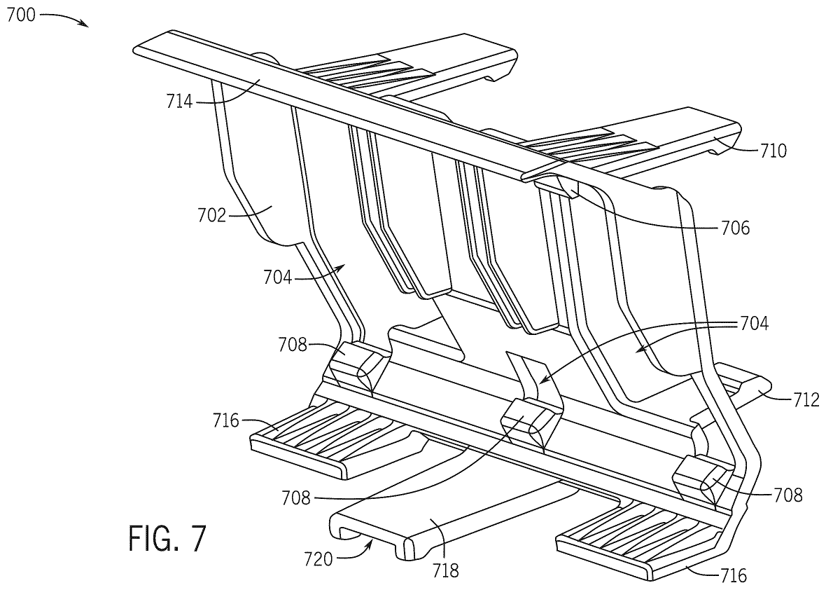

FIG. 7 is a front isometric view of an embodiment of a retainer 700. The retainer 700 comprises a frame 702 that comprises one or more apertures 704. The frame 702 may refer to a base piece or structure of the retainer 700 that other features and components extend from. The frame 702 may be a plastic component, a metal component, or another suitable material, and may be molded or 3D printed. The one or more apertures 704 may be of different sizes and shapes and may function to allow various wiring or other components (not depicted in FIG. 7) to pass through the frame 702. In at least one embodiment, the one or more apertures 704 may not be the same size, as shown herein, and further each of the one or more apertures 704 may include different sizes or shapes based on design conditions.

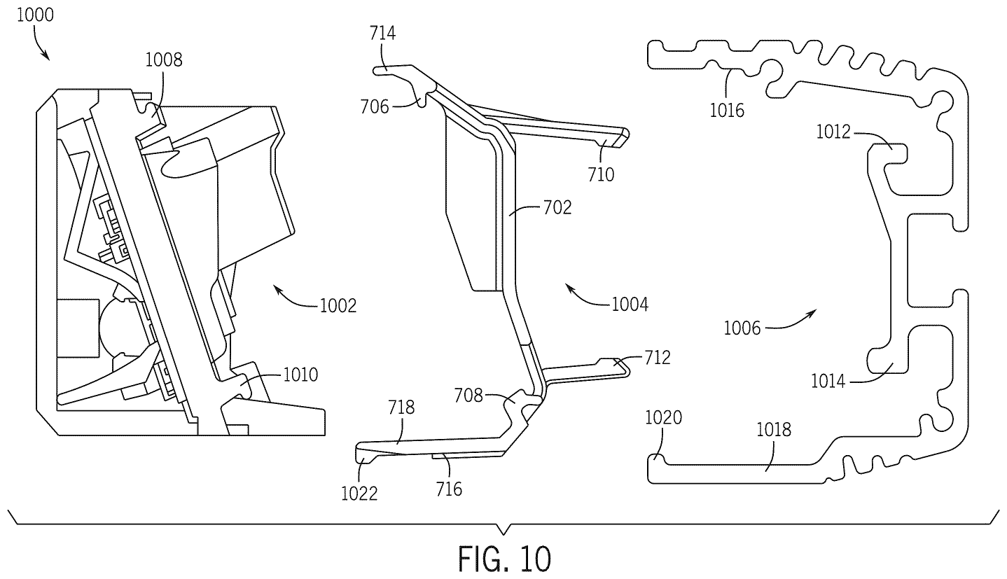

The retainer 700 may include one or more top barb-teeth 706 protruding from a front portion of the frame 702. It should be appreciated that although in FIG. 7 there is only a single top barb-teeth 706 depicted, there may be any reasonable number of top barb-teeth 706, which may be dependent on the required retaining force between the retainer 700 and a light head (not depicted in FIG. 7, but shown in FIG. 10).

The retainer 700 may also include one or more bottom barb-teeth 708 protruding from front of the frame 702. In this example, there are three bottom barb-tooth 708 visible, but it should be appreciated that there may be any reasonable number of bottom barb-teeth 708, which may be dependent on the required retaining force between the retainer 700 and the light head. The top barb-teeth 706 and bottom barb-teeth 708 may function by allowing the light head to snap into, and be retained by, the retainer 700.

The retainer 700 of FIG. 7 may also include one or more top cantilever snap legs 710 protruding from the rear of the frame 702. The top cantilever snap legs 710 may be at an angle oblique to portions of the frame 702, but the top cantilever snap legs 710 also may be perpendicular to portions of the frame 702. It should be appreciated that although in FIG. 7 there are two top cantilever snap legs 710 depicted, there may be any reasonable number of top cantilever snap legs 710, which may be dependent on the required retaining force between the retainer 700 and an extrusion of the light stick assembly (not depicted in FIG. 7, but shown in FIG. 10).

The retainer 700 may also include one or more bottom cantilever snap legs 712 protruding from the rear of the frame 702. The bottom cantilever snap legs 712 may be at an angle oblique to portions of the frame 702, but the bottom cantilever snap legs 712 also may be perpendicular to portions of the frame 702. Additionally, the top cantilever snap legs 710 may be at an angle oblique to the bottom cantilever snap legs 712, but also may be parallel. Furthermore, the angle between the top cantilever snap legs 710 and the bottom cantilever snap legs 712 may vary during engagement and disengagement of the retainer in the extrusion. Only one bottom cantilever snap leg 712 is visible to the viewer in FIG. 7, but it should be appreciated that there may be any reasonable number of bottom cantilever snap legs 712, which may be dependent on the required retaining force between the retainer 700 and the extrusion of the light stick assembly. The top cantilever snap legs 710 and bottom cantilever snap legs 712 may function by allowing the retainer 700 (typically with a light head retained in the retainer 700) to snap into, and be retained by, the extrusion of the light stick assembly.

Additionally, the retainer 700 may include a top cantilever member 714 protruding from the front of the frame 702. The top cantilever member 714 may be at an angle oblique to portions of the frame 702, but the top cantilever member 714 also may be perpendicular to portions of the frame 702. As depicted in FIG. 7, the top cantilever member 714 is a single piece extending the length of the frame 702, however, it should be appreciated that there also may be multiple top cantilever members 714 depending on the required engagement and tension between the top cantilever members 714 and the extrusion.

The retainer 700 also may include one or more bottom cantilever members 716 protruding from the front of the frame 702. The bottom cantilever members 716 may be at an angle oblique to portions of the frame 702, but the bottom cantilever members 716 also may be perpendicular to portions of the frame 702. Additionally, the top cantilever member 714 may be at an angle oblique to the bottom cantilever members 716, but also may be parallel. Furthermore, the angle between the top cantilever member 714 and the bottom cantilever members 716 may vary during engagement and disengagement of the light head in the retainer 700. It should be appreciated that although in FIG. 7 there are two bottom cantilever members 716 depicted, there may be any reasonable number of bottom cantilever members 716, which may be dependent on the required engagement and tension between the bottom cantilever members 716 and the extrusion. In this example, the one or more cantilever members 716 are positioned at opposite ends or sides (e.g., lateral sides) of the frame 702. Various embodiments may also include the one or more cantilever members 716 at intermediate positions along a lateral extent of the frame 702.

Also depicted in FIG. 7 is a cantilever safety 718 protruding from the front of the frame 702. In this example, the cantilever safety 718 is in substantially a common plane as the one or more cantilever members 716, in that each extend from a lower region of the frame 702. In other words, various embodiments may include the cantilever safety 718 and/or the one or more cantilever members 716 at an opposite vertical position than the top cantilever member 714. The cantilever safety 718 may itself be in an engaged or disengaged configuration when the retainer 700 snaps into the extrusion. When the cantilever safety 718 is engaged in the extrusion, the retainer 700 and/or light head may be secured to the extrusion of the light stick assembly. The disengaged configuration of the cantilever safety 718 may occur when the cantilever safety 718 is manipulated by an external tool (e.g., a screwdriver) to disengage the cantilever safety 718 from the extrusion to allow the removal of the retainer 700 and/or light head from the light stick assembly. As depicted in FIG. 7, there is only one cantilever safety 718, however, it should be appreciated that there also may be multiple cantilever safety 718 depending on the required engagement and tension between the cantilever safety 718 and the extrusion. However, a single cantilever safety 718 may facilitate ease of disengagement of the retainer 700 from the extrusion and decrease maintenance time when replacing or repairing light heads. In some embodiments of the retainer 700, there may be a relief location 720 positioned in the cantilever safety 718. The purpose of the relief location 720 may be to allow the external tool to make contact with the cantilever safety 718 in order to manipulate the cantilever safety 718 to the disengaged configuration and remove the retainer 700 and/or light head from the extrusion of the light stick assembly.

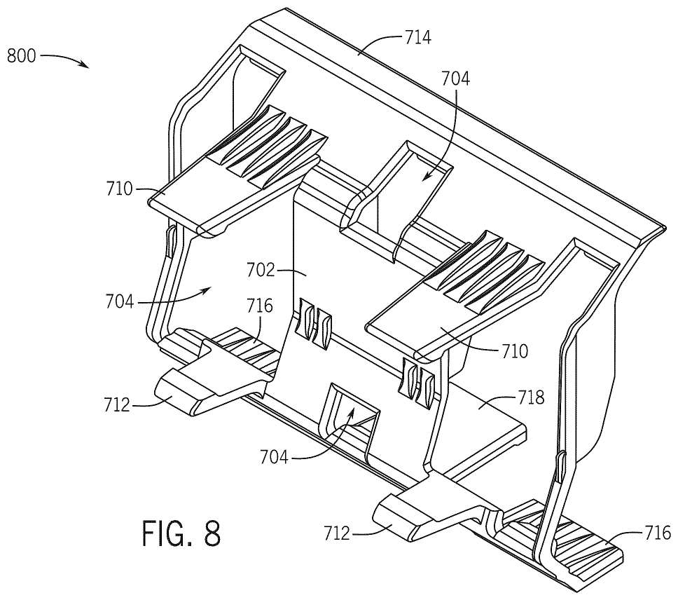

FIG. 8 is a rear isometric view of an embodiment of a retainer 800, which shares several similar features with the retainer 700 of FIG. 7, such as the frame 702, apertures 704, top cantilever snap legs 710, bottom cantilever members 716, and other features, which will be identified with like reference numerals for convenience purposes only and not to limit the scope of the present disclosure.

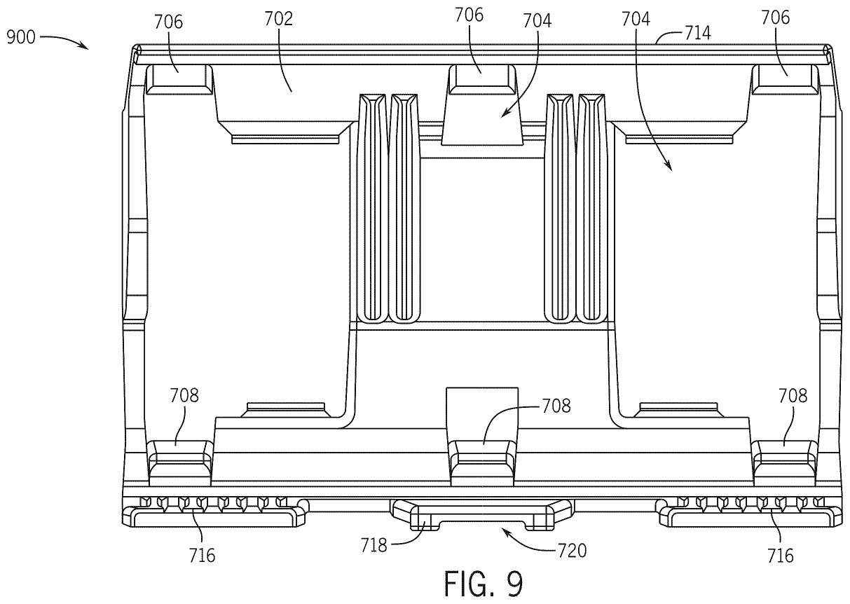

FIG. 9 is a front view of an embodiment of a retainer 900, which shares several similar features with the retainer 700 of FIG. 7 and the retainer 800 of FIG. 8, such as the frame 702, apertures 704, top barb-teeth 706, bottom cantilever members 716, and other features, which will be identified with like reference numerals for convenience purposes only and not to limit the scope of the present disclosure.

FIG. 10 is a side view of an embodiment of an expanded light stick assembly 1000, which shares several similar features with the retainer 700 of FIG. 7, retainer 800 of FIG. 8, and retainer 900 of FIG. 9, such as the top barb-teeth 706, top cantilever snap legs 710, bottom cantilever member 716, and other features, which will be identified with like reference numerals for convenience purposes only and not to limit the scope of the present disclosure. The light stick assembly 1000 may include three main pieces: a light head 1002, a retainer 1004, and an extrusion 1006. The three pieces have been expanded, as depicted in FIG. 10, which may be considered the disassembled configuration of the light stick assembly 1000. It should be appreciated that in the illustrated embodiment of FIG. 10, the fully populated light stick assembly 1000 has a single retainer 1004 per each light head 1002, however, in some embodiments, there may be multiple light heads 1002 per each retainer 1004, with the retainer 1004 having an elongated shape to account for the width of multiple light heads 1002.

The light head 1002 of the light stick assembly 1000 may include a top hook channel 1008 and a bottom hook channel 1010. When the light head 1002 is moved towards the retainer 1004 in substantially the relative alignment illustrated in FIG. 10, the top hook channel 1008 may latch or otherwise connect with the top barb-teeth 706 of the retainer 1004, and the bottom hook channel 1010 may latch or otherwise connect with the bottom barb-teeth 708 of the retainer 1004. For example, the top barb-teeth 706 may refer to one or more protruding sections that extend into one or more recesses associated with the top hook channel 1008. Similarly, one or more protrusions of the bottom hook channel 1010 may capture or otherwise partially surround at least a portion of the bottom barb-teeth 708. The connection of the top hook channel 1008 with the top barb-teeth 706 and the connection of the bottom hook channel 1010 with the bottom barb-teeth 708 may retain the light head 1002 within the cavity of the retainer 1004, which may be considered the light head 1002 and retainer 1004 subassembly. Upon making up the connections, the light head 1002 may “snap” into the retainer 1004. In some embodiments, the retainer 1004 has two rows of barb-teeth 706, 708 each consisting of three teeth (not depicted in FIG. 10), that oppose each other, so they can work together to hold onto the back of the light head 1002. When the light head 1002 and retainer 1004 are pressed together for assembly, during the initial interference of the two parts, the geometry of the retainer 1004 allows the retainer 1004 to flex such that these two rows of teeth 706, 708 may be translated away from each other. Once the interference is cleared, the spring force is relieved as the teeth 706, 708 return to their relaxed positions, and then engage into the hook channels 1008, 1010 on the back of the light head 1002, creating a new subassembly.

The extrusion 1006 of the light stick assembly 1000 may include a top cantilever snap barb catch 1012 and a bottom cantilever snap barb catch 1014. When the retainer 1004 or the light head 1002 and retainer 1004 subassembly, is moved towards the extrusion 1006 in substantially the relative alignment illustrated in FIG. 10, the top cantilever snap legs 710 of the retainer 1004 may latch or otherwise connect with the top cantilever snap barb catch 1012, and the bottom cantilever snap legs 712 of the retainer 1004 may latch or otherwise connect with the bottom cantilever snap barb catch 1014. The connection of the top cantilever snap legs 710 with the top cantilever snap barb catch 1012 and the connection of the bottom cantilever snap legs 712 with the bottom cantilever snap barb catch 1014 may retain the retainer 1004 or the light head 1002 and retainer 1004 subassembly in the extrusion 1006 of the light stick assembly 1000. Upon making up the connections, the retainer 1004 or the light head 1002 and retainer 1004 subassembly may “snap” into the extrusion 1006. In some embodiments, the snap legs 710, 712, which comprise two pairs of opposing cantilever snap barbs 710, 712 that engage into the inside of the extrusion 1006 when installed. The extrusion 1006 has a cross sectional profile that allows for these snap barbs 710, 712 on the retainer 1004 to engage and disengage when the light head 1002 is moved in a lateral motion. The snap barbs 710, 712 together form a pinned joint between the retainer 1004 or light head 1002 and retainer 1004 subassembly and the extrusion 1006.

As described herein, the retainer 1004 may include one or more top cantilever members 714 and one or more bottom cantilever members 716. The cantilever members 714, 716 may be designed to interfere with one or more inside walls 1016, 1018 of the extrusion 1006 during assembly. The cantilever members 714, 716 are flexed out of the way of the interference, which creates equal and opposite spring forces to center the weight distribution of the retainer 1004 or the retainer 1004 and light head 1002 subassembly within the extrusion 1006 that would otherwise rotate around the pinned joint inside the extrusion 1006. For example, the top cantilever member 714 may provide spring force in a downwards direction by the tension applied to the top inside wall 1016 of the extrusion 1006, and the bottom cantilever member 716 may provide spring force in an upwards direction by the tension applied to the bottom inside wall 1018 of the extrusion 1006.

Also depicted in FIG. 10 is a safety stopping feature 1020 of the extrusion 1006. The cantilever safety 718 may be located on the bottom of the retainer 1004, and may be centered in between the bottom cantilever members 716, that acts as a “catch” or a “safety,” functioning by ensuring the retainer 1004 or light head 1002 and retainer 1004 subassembly stays connected to or “snapped in” to the extrusion 1006 of the light stick assembly 1000. This cantilever safety 718 may also be designed to interfere with the bottom inside wall 1018 of the extrusion 1006, but the length of the cantilever safety 718 piece is also intended to engage into a safety stopping feature 1020 on the bottom of the extrusion 1006. The cantilever safety 718 may comprise one or more pads 1022 on the end of the cantilever safety 718 to engage the safety stopping feature 1020. During disassembly of the retainer 1004 or the light head 1002 and retainer 1004 subassembly from the extrusion 1006, the cantilever safety 718 may be manipulated with an external tool (not depicted in FIG. 10). The cantilever safety 718 may be flexed or bent enough to allow for the pads 1022 to clear the safety stopping feature 1020 of the extrusion 1006, which may allow for the retainer 1004 or the light head 1002 and retainer 1004 subassembly to be removed from the light stick assembly 1000.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A light assembly, comprising:
one or more light heads;
one or more retainers configured to couple to the one or more light heads; and
an enclosure configured to receive the one or more retainers to secure the one or more light heads in a desired orientation.

2. The light assembly of claim 1, wherein the one or more light heads further comprise:
a first light source configured to direct output light associated with a flood section; and
a second light source configured to direct output light associated with a forward illumination section.

3. The light assembly of claim 2, wherein the first light source and the second light source each comprise one or more light emitting diodes (LEDs).

4. The light assembly of claim 2, wherein the flood section includes a flood optical axis that is substantially normal to a board on which the first light source and the second light source are mounted and the forward illumination section includes a forward illumination optical axis that is substantially parallel to a ground plane.

5. A light head, comprising:
a printed circuit board arranged at a first angle;
a first light section, comprising:
a first light source;
a first reflector; and
a second reflector;
wherein the first light source includes a first optical axis that is substantially normal to the printed circuit board; and
a second light section, comprising:
a second light source;
a third reflector;
a fourth reflector;
a collimator; and
two or more diamond optical reflectors;
wherein the second light source includes a second optical axis that is at a second angle, the second angle being oblique to the first angle of the printed circuit board, and the second angle being substantially parallel to a ground plane.

6. The light head of claim 5, wherein a first diamond optical reflector of the two or more diamond optical reflectors is positioned at a first lateral side of the second light source and a second diamond optical reflector of the two or more diamond optical reflectors is positioned at a second lateral side of the second light source.

7. The light head of claim 5, wherein the first light source and the second light source each comprise one or more light emitting diodes (LEDs).

8. The light head of claim 5, further comprising:
a power supply; and
a controller configured to receive one or more control signals to direct the power supply to provide a designated power level to one or both of the first light source or the second light source.

9. The light head of claim 8, wherein the one or more control signals are received, by the controller, from a central controller associated with a plurality of additional light heads.

10. The light head of claim 9, wherein the plurality of additional light heads and the light head are configured to be synchronized.

11. A method, comprising:
determining a first power level for a first light source;
causing the first light source to operate at the first power level;
determining a second power level for a second light source;
determining a total power level based on the first power level and the second power level;
determining the total power level exceeds a threshold power level;
determining a modified first power level;
causing the first light source to operate at the modified first power level; and
causing the second light source to operate at the second power level.

12. The method of claim 11, wherein the modified first power level is less than the first power level.

13. The method of claim 11, wherein the threshold power level is a maximum power level for a lighting unit.

14. A retainer for holding a light head, attachable to an enclosure, comprising:
a frame comprising one or more apertures;
one or more front top members configured to apply force to an upper interior part of an enclosure;
one or more front bottom members configured to apply force to a bottom interior part of the enclosure;
one or more rear members connectable to one or more catches in the extrusion; and
one or more safety members comprising one or more pads, the one or more safety members ensuring the attachment of the retainer to the enclosure.

15. The retainer of claim 14, wherein the retainer further comprises a light head attached to the retainer.

16. The retainer of claim 15, wherein the light head is attached to the retainer via one or more teeth.

17. The retainer of claim 16, wherein the one or more teeth of the retainer are translated away from each other during the attachment of the light head to the retainer.

18. The retainer of claim 14, wherein the one or more front top members and the one or more front bottom members substantially prevent rotation between the retainer and the enclosure.

19. The retainer of claim 14, wherein the one or more pads of the one or more safety members engage a safety stopping feature of the enclosure.

20. The retainer of claim 14, wherein the safety member is configured to be manipulatable with an external tool to move the safety member into an engaged configuration or a disengaged configuration.
